(19) United States
(12) Patent Application Publication
(10) Pub. No.: US 2011/0167202 A1
(43) Pub. Date: Jul. 7, 2011

(54) ACCESS CONTROL APPARATUS

(75) Inventor: Takahiro MIOMO, Higashiosaka-shi (JP)

(73) Assignee: SANYO ELECTRIC CO., LTD., Osaka (JP)

(21) Appl. No.: 12/986,911

(22) Filed: Jan. 7, 2011

(30) Foreign Application Priority Data
Jan. 7, 2010 (JP) 2010-1628

(51) Int. Cl. G06F 12/00

(52) U.S. Cl. 711/103; 711/E12.001

(57) ABSTRACT

An access control apparatus includes a plurality of accesses. A plurality of accessors are respectively allocated to a plurality of operation modes in order to access a recording medium having a plurality of partitions and identification information which identifies a location of the plurality of partitions. An acceptor accepts a selection operation which selects any one of the plurality of operation modes. A first designator designates, based on the identification information provided in the recording medium, a part of partitions corresponding to the operation mode selected by the selection operation out of the plurality of partitions. A permitter permits an accessor corresponding to the operation mode selected by the selection operation out of the plurality of accessors to access the partition designated by the first designator.

### CROSS REFERENCE OF RELATED APPLICATION

The disclosure of Japanese Patent Application No. 2010-1628, which was filed on Jan. 7, 2010, is incorporated herein by reference.

### BACKGROUND OF THE INVENTION

1. Field of the Invention

The present invention relates to an access control apparatus. More particularly, the present invention relates to an access control apparatus which controls an access operation to a recording medium in which a plurality of partitions are formed.

2. Description of the Related Art

According to one example of this type of apparatus, a CPU, an EEPROM (registered trademark), and a flash memory are implemented in a module of a semiconductor memory card. A region of use of an EC client application arranged in the EEPROM is extended by placing a partition table at the EEPROM and creating a partition in the flash memory. Since the partition table is placed at the EEPROM in the module, only the CPU in the module is able to access the partition table. Thereby, a confidentiality of the EC client application is increased.

However, in the above-described apparatus, an accessible partition is not creatively used depending on an operation mode, and thus, there is a limit to usability of the recording medium.

### SUMMARY OF THE INVENTION

An access control apparatus according to the present invention, comprises: a plurality of accessors which are respectively allocated to a plurality of operation modes in order to access a recording medium having a plurality of partitions and identification information which identifies each of the plurality of partitions; an acceptor which accepts a selection operation which selects any one of the plurality of operation modes; a first designator which designates, based on the identification information provided in the recording medium, a part of partitions corresponding to the operation mode selected by the selection operation out of the plurality of partitions; and a permitter which permits an accessor corresponding to the operation mode selected by the selection operation out of the plurality of accessors to access the partition designated by the first designator.

An access control program product according to the present invention is an access control program product executed by a processor of an access control apparatus, comprises: a plurality of accessing steps which are respectively allocated to a plurality of operation modes in order to access a recording medium having a plurality of partitions and identification information which identifies each of the plurality of partitions; an accepting step which accepts a selection operation which selects any one of the plurality of operation modes; a designating step which designates, based on the identification information provided in the recording medium, a part of partitions corresponding to the operation mode selected by the selection operation out of the plurality of partitions; and a permitting step which permits an accessing step corresponding to the operation mode selected by the selection operation out of the plurality of accessing steps to access the partition designated by the designating step.

An access control method according to the present invention is an access control method executed by an access control apparatus, comprises: a plurality of accessing steps which are respectively allocated to a plurality of operation modes in order to access a recording medium having a plurality of partitions and identification information which identifies each of the plurality of partitions; an accepting step which accepts a selection operation which selects any one of the plurality of operation modes; a designating step which designates, based on the identification information provided in the recording medium, a part of partitions corresponding to the operation mode selected by the selection operation out of the plurality of partitions; and a permitting step which permits an accessing step corresponding to the operation mode selected by the selection operation out of the plurality of accessing steps to access the partition designated by the designating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an NOR-type flash memory;

FIG. 4 is an illustrative view showing one example of a mapping state of an NAND-type flash memory;

FIG. 5(A) is an illustrative view showing one example of a setting state of a register when a camera mode or a reproducing mode is selected;

FIG. 5(B) is an illustrative view showing one example of a setting state of the register when a setting change mode is selected;

FIG. 5(C) is an illustrative view showing one example of a setting state of the register when an USB communication mode is selected;

FIG. 6(A) is an illustrative view showing one example of a mapping state of the NAND-type flash memory recognized by each of an imaging task and a reproducing task;

FIG. 6(B) is an illustrative view showing one example of a mapping state of the NAND-type flash memory recognized by a setting change task;

FIG. 6(C) is an illustrative view showing one example of a mapping state of the NAND-type flash memory recognized by an USB communication task;

FIG. 7(A) is an illustrative view showing one example of a menu screen;

FIG. 7(B) is an illustrative view showing another example of the menu screen;

FIG. 8 is a flowchart showing one portion of behavior of a CPU applied to the embodiment in FIG. 2;

FIG. 9 is a flowchart showing another portion of behavior of the CPU applied to the embodiment in FIG. 2;

FIG. 10 is a flowchart showing still another portion of behavior of the CPU applied to the embodiment in FIG. 2;

FIG. 11 is a flowchart showing yet another portion of behavior of the CPU applied to the embodiment in FIG. 2;

FIG. 12 is a flowchart showing another portion of behavior of the CPU applied to the embodiment in FIG. 2;

FIG. 13 is a flowchart showing still another portion of behavior of the CPU applied to the embodiment in FIG. 2;

### DETAILED DESCRIPTION OF THE PREFERRED EMBODIMENTS

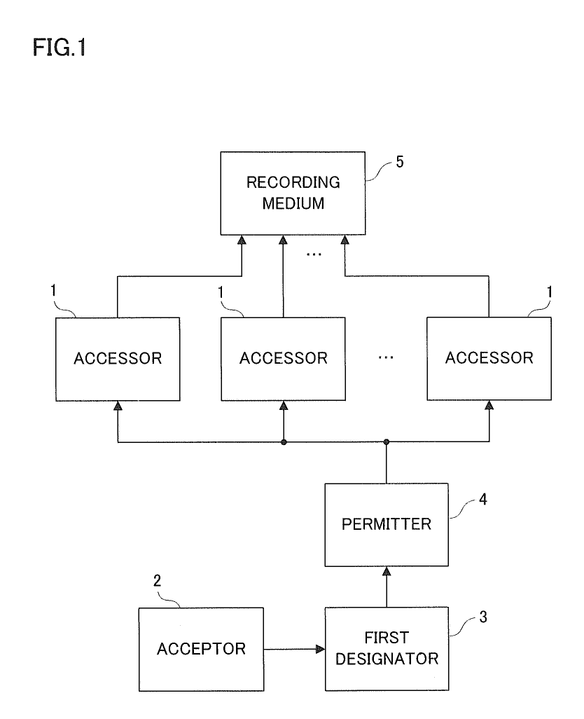

With reference to FIG. 1, an access control apparatus of one embodiment of the present invention is basically configured as follows: A plurality of accessors 1, 1, . . . are respectively allocated to a plurality of operation modes in order to access a recording medium 5 having a plurality of partitions and identification information which identifies the plurality of partitions. An acceptor 2 accepts a selection operation which selects any one of the plurality of operation modes. A first designator 3 designates, based on the identification information provided in the recording medium 5, a part of partitions corresponding to the operation mode selected by the selection operation out of the plurality of partitions. A permitter 4 permits an accessor 1 corresponding to the operation mode selected by the selection operation out of the plurality of accessors 1, 1, . . . to access the partition designated by the first designator 3.

By preparing the identification information which identifies each of the plurality of partitions in the recording medium 5, it becomes possible to avoid misrecognition of the partitions attributed to a change of a program which controls to access the recording medium 5. Moreover, by permitting the accessor 1 corresponding to the selected operation mode to access the designated partition, it becomes possible to creatively use the recording medium 5 depending on the operation mode. Thus, usability of the recording medium 5 having the plurality of partitions is improved.

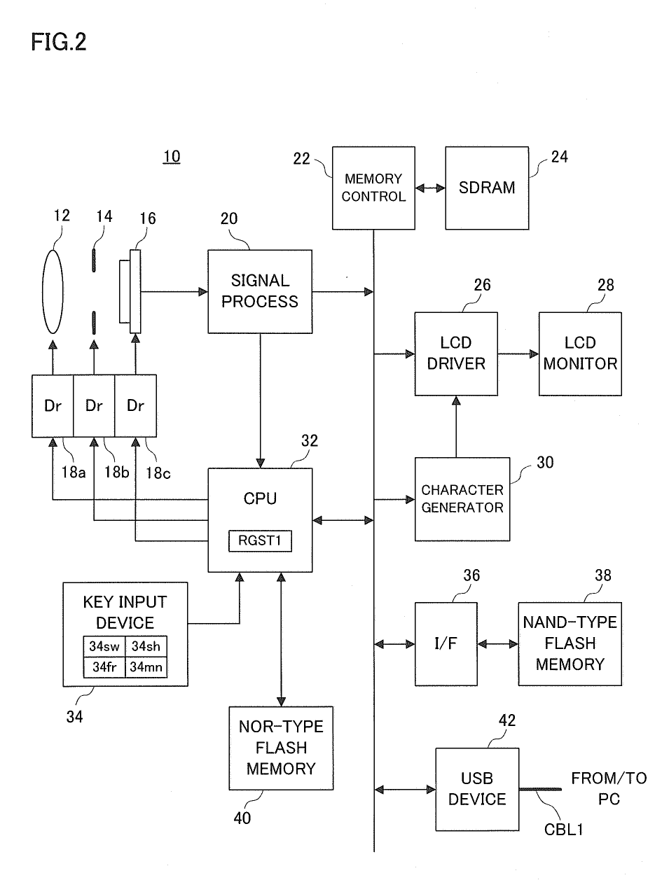

With reference to FIG. 2, a digital camera 10 according to this embodiment includes a focus lens 12 and an aperture unit 14 respectively driven by drivers 18a and 18b. An optical image of the scene that undergoes these components enters, with irradiation, the imaging surface of an imager 16, and is subjected to a photoelectric conversion.

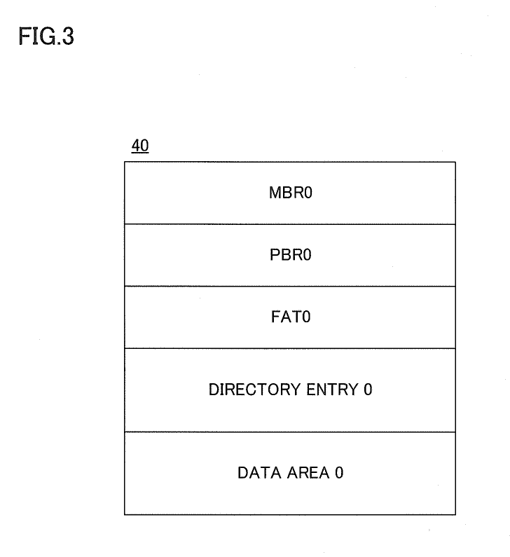

When a power source is applied, a CPU 32 accesses an NOR-type flash memory 40. With reference to FIG. 3, the flash memory 40 has an MBR0 (MBR: Master Boot Record), a PBR0 (PBR: Partition Boot Record), an FAT0 (FAT: File Allocation Table), a directory entry 0 and a data area 0. Herein, in the data area 0, an OS (Operating System) which conforms to the IRON, a program which is equivalent to a plurality of tasks (details are described later) executed under the OS, and font data which forms a basis for texts representing menu items are accommodated.

Firstly, the CPU 32 recognizes a mapping state of the flash memory 40 with reference to descriptions of the MBR0 and the PBR0, and thereafter starts up the OS and a main task with reference to the FAT0 and the directory entry 0.

In the main task, a setting (i.e., an operation mode at a current time point) of a mode selector switch 34sw arranged in a key input device 34 is determined, so as to start up a task corresponding to the operation mode at the current time point. If the operation mode at the current time point is a camera mode, an imaging task is started up, and if the operation mode at the current time point is a reproducing mode, a reproducing task is started up. Moreover, if the operation mode at the current time point is a setting change mode, a setting change task is started up, and if the operation mode at the current time point is an USB communication mode, an USB communication task is started up.

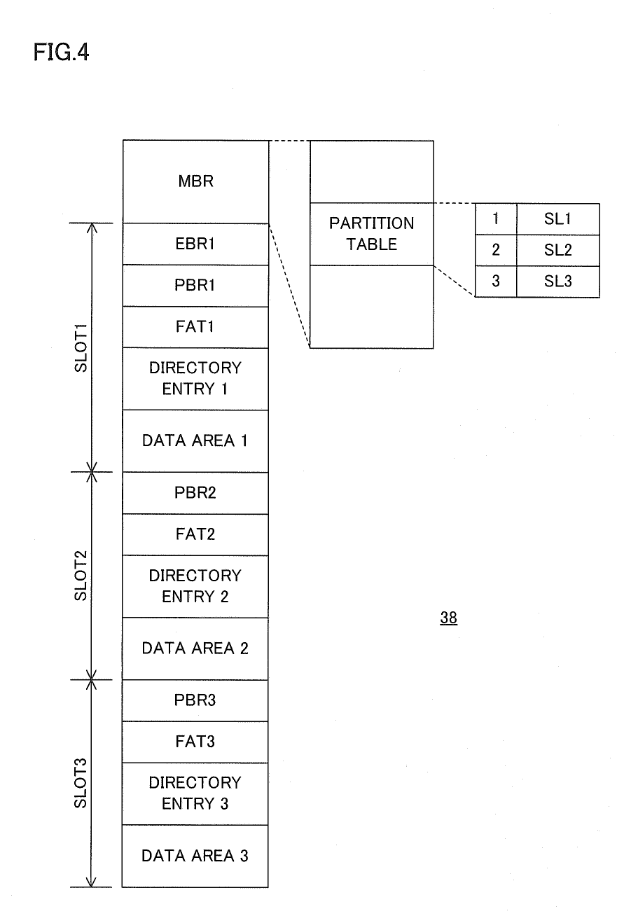

In any of the camera mode, the reproducing mode, the setting change mode and the USB communication mode, an NAND-type flash memory 38 is accessed. With reference to FIG. 4, the flash memory 38 has a single MBR and three slots 1 to 3. It is noted that the slot has the same meaning as the “partition”.

The MBR is a portion which defines a mapping state of each of slots 1 to 3, and a partition table of the MBR is formed by columns 1 to 3. A slot number SL1 identifying the slot 1 is described in the column 1, a slot number SL2 identifying the slot 2 is described in the column 2, and a slot number SL3 identifying the slot 3 is described in the column 3. Thus, an order of slot numbers arrayed in the partition table matches an order of an array of the slots 1 to 3, and a column number and a slot number corresponding to each other indicate a common numerical value.

The slot 1 is formed by an EBR1 (EBR: Extended Boot Record), a PBR1, an FAT1, a directory entry 1 and a data area 1, the slot 2 is formed by a PBR2, an FAT2, a directory entry 2 and a data area 2, and the slot 3 is formed by a PBR3, an FAT3, a directory entry 3 and a data area 3.

The EBR1 of the slot 1 defines only a mapping state of the slot 1, out of the slots 1 to 3. Thus, a mapping state of the slots 2 and 3 is recognized by referring to the MBR, and the mapping state of the slot 1 is recognized by referring to the MBR or the EBR1.

Moreover, the data area 1 is prepared for accommodating an image file, the data area 2 is prepared for accommodating alternate font data instead of font data accommodated in the flash memory 40, and the data area 3 is prepared for accommodating operation manual data of the digital camera 10.

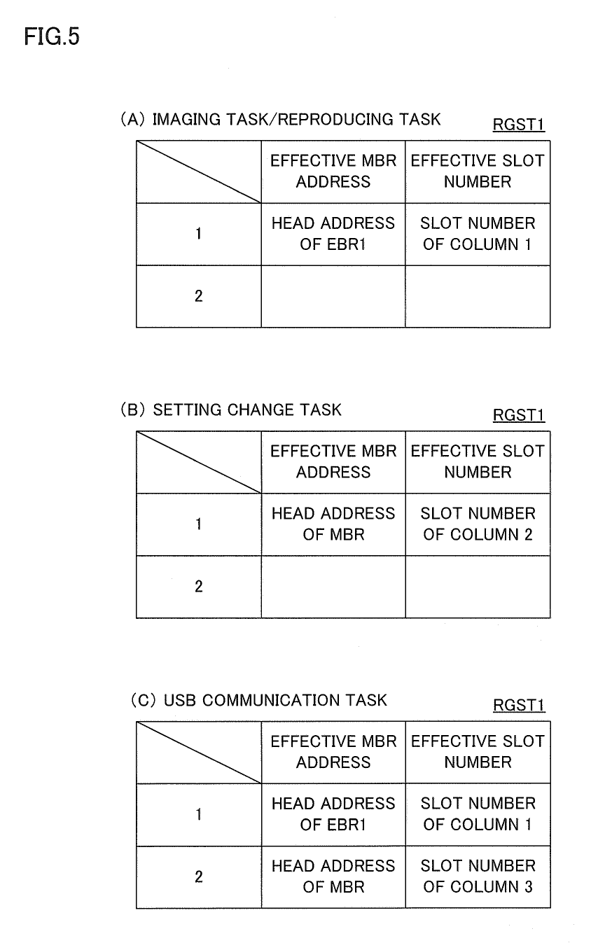

When the imaging task or the reproducing task is started up, a head address of the EBR1 is set to the column 1 of a register RGST1 as an effective MBR address, and the slot number described in the column 1 of the partition table is set to the column 1 of the register RGST1 as an effective slot number (see FIG. 5(A)). It is noted that the head address of the EBR1 is specified by referring to the MBR.

Moreover, when the setting change task is started up, a head address of the MBR is set to the column 1 of the register RGST1 as the effective MBR address, and the slot number described in the column 2 of the partition table is set to the column 1 of the register RGST1 as the effective slot number (see FIG. 5(B)).

Furthermore, when the USB communication task is started up, the head address of the EBR1 and the head address of the MBR are respectively set as the effective MBR addresses to the columns 1 and 2 of the register RGST1, and the slot numbers described in the columns 1 and 3 of the partition table are respectively set as the effective slot numbers to the columns 1 and 2 of the register RGST1 (see FIG. 5(C)).

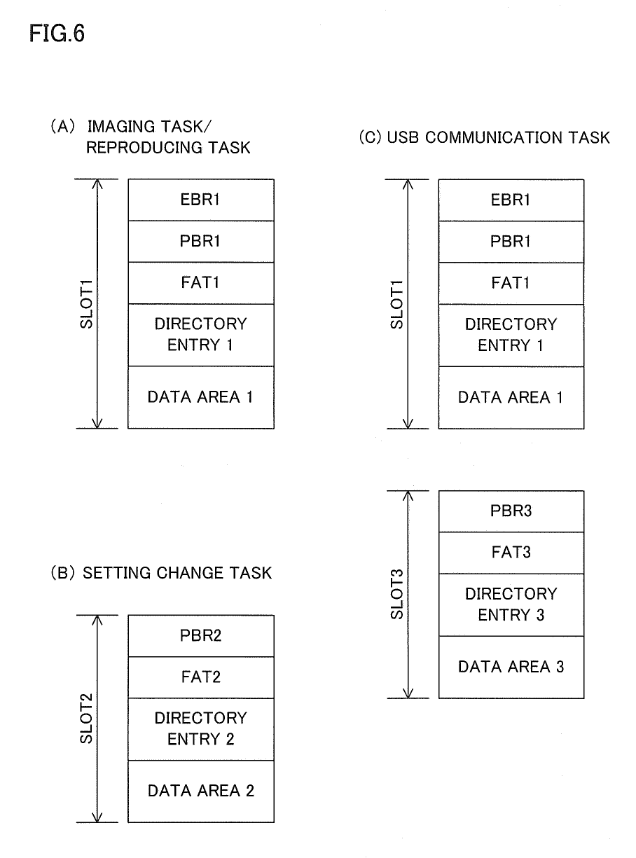

The started-up task refers to the setting of the register RGST1, i.e., refers to a description corresponding to the effective slot number out of descriptions of boot records starting from the effective MBR address, so as to recognize the mapping state of the flash memory 38. Thus, under the imaging task and the reproducing task, the flash memory 38 is recognized as having a mapping shown in FIG. 6(A). Moreover, under the setting change task, the flash memory 38 is recognized as having a mapping shown in FIG. 6(B). Moreover, under the USB communication task, the flash memory 38 is recognized as having a mapping shown in FIG. 6(C).

As a result, the started-up task accesses the flash memory 38 without taking into consideration of an actual mapping state of the flash memory 38. The memory access that does not need to consider the actual mapping state is realized by describing the slot numbers SL1 to SL3 on the partition table of the MBR and setting to the register RGST1 a slot number which identifies a slot in which an access is permitted.

When the imaging task is started up, the CPU 32 commands a driver 18c to repeat an exposure procedure and an electric-charge reading-out procedure in order to execute a moving-image taking process. In response to a vertical synchronization signal Vsync that is cyclically generated, the driver 18c exposes the imaging surface of the imager 16 and reads out electric charges produced on the imaging surface in a raster scanning manner. From the imager 16, raw image data based on the read-out electric charges is cyclically outputted.

A signal processing circuit 20 performs processes, such as white balance adjustment, color separation, and YUV conversion, on the raw image data outputted from the imager 16, and writes YUV formatted-image data, which is produced as a result of these processes, into an SDRAM 24 through a memory control circuit 22. An LCD driver 26 repeatedly reads out the image data accommodated in the SDRAM 24 through the memory control circuit 22, and drives an LCD monitor 28 based on the read-out image data. As a result, a moving image representing a scene is displayed on a monitor screen.

Out of the image data produced by the signal processing circuit 20, Y data is applied also to the CPU 32. The CPU 32 performs a simple AE process on the applied Y data so as to calculate an appropriate EV value. An aperture amount and an exposure time defining the calculated appropriate EV value are respectively set to the drivers 18b and 18c, and as a result, a brightness of the moving image is moderately adjusted.

When a shutter button 34sh is half depressed, the CPU 32 performs a strict AE process on the Y data applied from the signal processing circuit 20 so as to calculate an optimal EV value. Similarly to the above-described case, an aperture amount and an exposure time defining the calculated optimal EV value are respectively set to the drivers 18b and 18c. As a result, the brightness of the moving image is adjusted strictly. Moreover, the CPU 32 performs an AF process on a high-frequency component of the Y data applied from the signal processing circuit 20. Thereby, the focus lens 12 is placed at a focal point, and thus, a sharpness of the moving image is improved.

When the shutter button 34sh is fully depressed, the CPU 32 commands an I/F 36 to execute a recording process. The I/F 36 reads out one frame of the image data representing the scene at a time point at which the shutter button 34sh is operated, from the SDRM 24 through the memory control circuit 22, and writes an image file including the read-out image data into the data area 1 of the flash memory 38. Furthermore, the OF 36 updates the directory entry 1 and the FAT1 in association with the writing process.

When the reproducing task is started up, the CPU 32 detects the latest image file accommodated in the data area 1 with reference to the directory entry 1, and commands the I/F 36 and the LCD driver 26 to execute a reproduction process in which the detected image file is noticed. The I/F 36 reads out the image data of a designated image file with reference to the FAT1, and writes the read-out image data into the SDRAM 24 through the memory control circuit 22.

An LCD driver 26 reads out the image data accommodated in the SDRAM 24, through the memory control circuit 22, and drives the LCD monitor 28 based on the read-out image data. As a result, a reproduction image based on the image data of the designated image file is displayed on the LCD monitor 28.

When a forward/backward button 34fr of the key input device 34 is operated, the CPU 32 refers to the directory entry 1 so as to detect a succeeding image file or a preceding image file. The detected image file is subjected to the reproduction process similar to that described above and as a result, the reproduction image is updated.

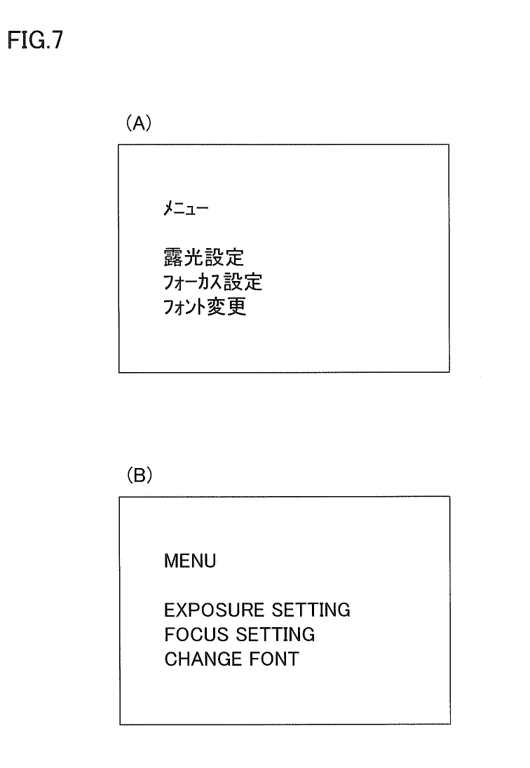

When the setting change task is started up, the CPU 32 applies the font data accommodated in the flash memory 40 to a character generator 30 in order to display a menu image. The character generator 30 creates menu image data based on the applied font data so as to apply the created menu image data to the LCD driver 26. As a result, the menu image shown in FIG. 7(A) is displayed on the LCD monitor 28.

Herein, when an item of [symbol] is selected, an exposure mode is changed. Moreover, an item of [symbol] is selected, a focus mode is changed. The AE process and the AF process executed in response to the half-depression of the shutter button 34sh under the imaging task is executed in a manner according to thus set exposure mode and focus mode.

Moreover, when [symbol] is selected on the menu image shown in FIG. 7(A), the CPU 32 reads out the alternate font data accommodated in the data area 2 of the flash memory 38 through the I/F 36, so as to overwrite the read-out alternate font data to the font data accommodated in the data area 0 of the flash memory 40. As a result, the menu image is updated from FIG. 7(A) to FIG. 7(B).

When the USB communication task is started up, it is determined whether or not a USB cable CBL1 is connected to a USB device 42. When the determined result indicates a non-connected state, a predetermined notification is outputted while when the determined result indicates a connected state, menu data described with two items of “operation manual” and “image file” is transferred to a PC (not shown) through the USB device 42.

When an item selected by the PC is “operation manual”, the CPU 32 reads out the operation manual data accommodated in the data area 3 of the flash memory 38 through the I/F 36 so as to transfer the read-out operation manual data to the PC through the USB device 42. As a result, the operation manual is displayed on a screen of the PC.

On the other hand, when an item selected by the PC is “image file”, the CPU 32 reads out the image file accommodated in the data area 1 of the flash memory 38 through the I/F 36 so as to transfer the read-out image file to the PC through the USB device 42. As a result, the image file is reproduced by the PC.

It is noted that since the EBR1 arranged in the slot 1 is accessible by the PC, and the EBR1 defines only the mapping state of the slot 1, the PC recognizes that the flash memory 38 has only the slot 1.

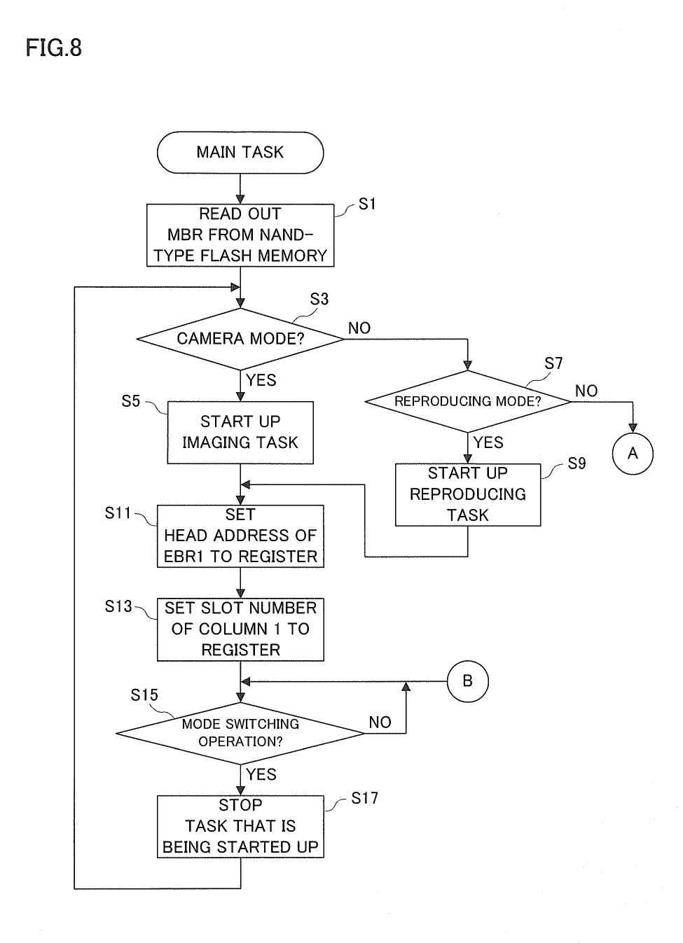

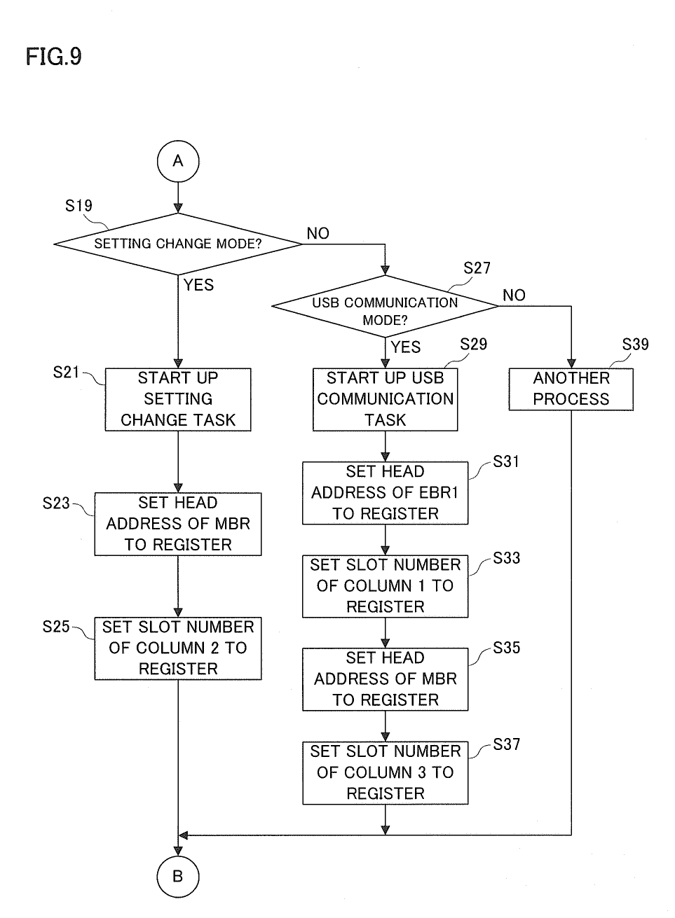

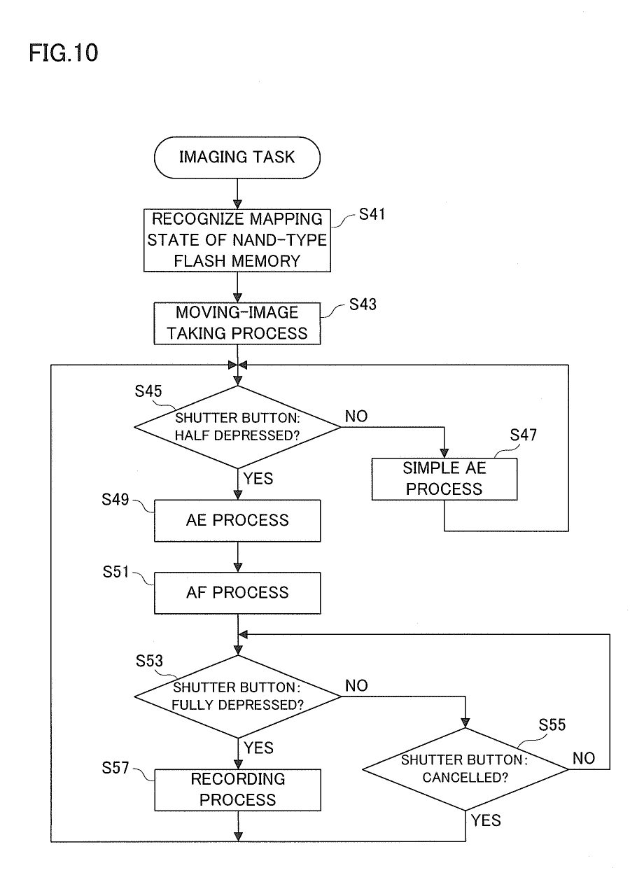

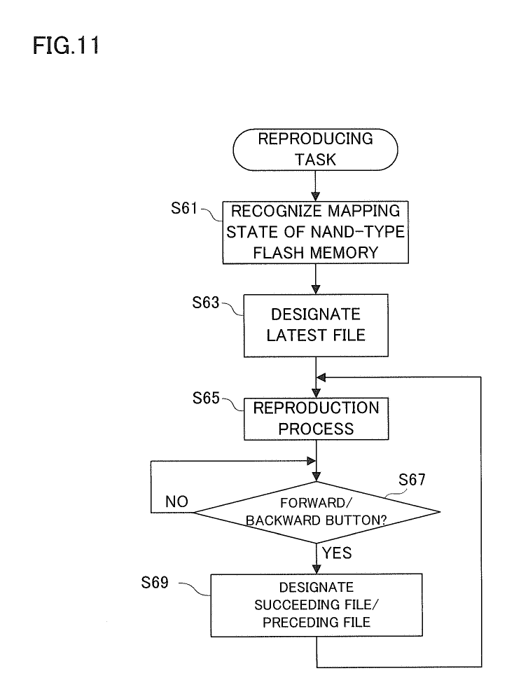

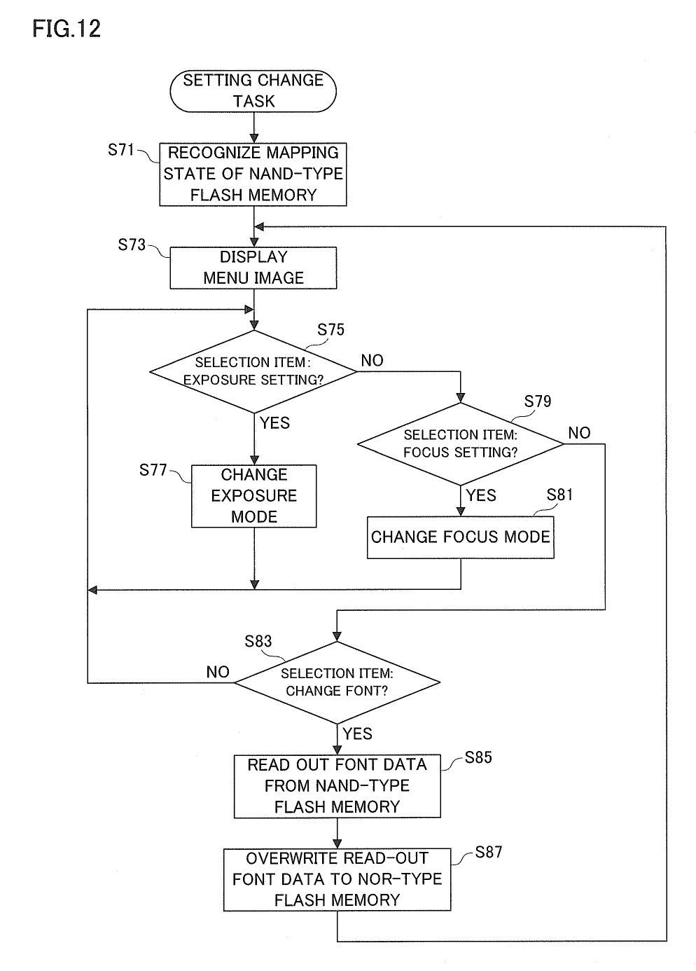

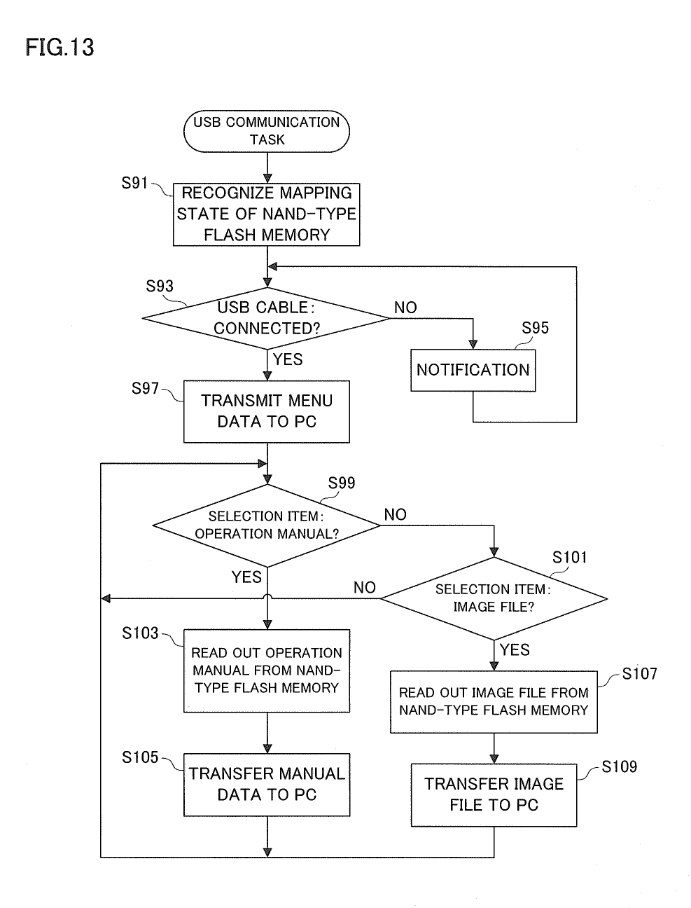

The CPU 32 executes the main task shown in FIG. 8 and FIG. 9 irrespective of the operation mode, and also executes following tasks: the imaging task shown in FIG. 10 is executed when the camera mode is selected; the reproducing task shown in FIG. 11 is executed when the reproducing mode is selected; the setting change task shown in FIG. 12 is executed when the setting change mode is selected; and the USB communication task shown in FIG. 13 is executed when the USB communication mode is selected.

With reference to FIG. 8, in a step S1, the MBR is read out from the flash memory 38. In a step S3, it is determined whether or not the operation mode at the current time point is the camera mode, and in a step S7, it is determined whether or not the operation mode at the current time point is the reproducing mode. Moreover, in a step S19, it is determined whether or not the operation mode at the current time point is the setting change mode, and in a step S27, it is determined whether or not the operation mode at the current time point is the USB communication mode.

When YES is determined in the step S3, the imaging task is started up in a step S5, and when YES is determined in the step S7, the reproducing task is started up in a step S9. Upon completion of the process in the step S5 or S9, the process advances to a step S11 so as to set the head address of the EBR1 to the column 1 of the register RGST1 as the effective MBR address. In a step S13, the slot number described in the column 1 of the partition table is set to the column 1 of the register RGST1 as the effective slot number.

In a step S15, it is repeatedly determined whether or not the mode switching operation is performed, and when the determined result is updated from NO to YES, the task that is being started up is stopped in a step S17. Upon completion of the stop process, the process returns to the step S3.

When YES is determined in the step S19, the setting change task is started up in a step S21. In a step S23, the head address of the MBR is set to the column 1 of the register RGST1 as the effective MBR address, and in a step S25, the slot number described in the column 2 of the partition table is set to the column 1 of the register RGST1 as the effective slot number. Upon completion of the process in the step S25, the process advances to the step S15.

When YES is determined in the step S27, the USB communication task is started up in a step S29. In a step S31, the head address of the EBR1 is set to the column 1 of the register RGST1 as the effective MBR address, and in a step S33, the slot number described in the column 1 of the partition table is set to the column 1 of the register RGST1 as the effective slot number.

In a step S35, the head address of the MBR is set to the column 2 of the register RGST1 as the effective MBR address, and in a step S37, the slot number described in the column 3 of the partition table is set to the column 2 of the register RGST1 as the effective slot number. Upon completion of the process in the step S37, the process advances to the step S15.

It is noted that, if the operation mode at the current time point is not any of the camera mode, the reproducing mode, the setting change mode and the USB communication mode, another process is executed in a step S39, and thereafter, the process advances to the step S15.

With reference to FIG. 10, in a step S41, the mapping state of the flash memory 38 is recognized with reference to the register RGST1 which is set as shown in FIG. 5(A). As a result, the flash memory 38 is recognized as having the mapping shown in FIG. 6(A).

In a step S43, the moving-image taking process is executed. As a result, a through image representing the scene is displayed on the LCD monitor 28. In a step S45, it is determined whether or not the shutter button 34sh is half depressed, and as long as the determined result is NO, the simple AE process in a step S47 is repeated. As a result, a brightness of the through image is adjusted moderately.

When the shutter button 34sh is half depressed, the AE process is executed in a step S49, and the AF process is executed in a step S51. As a result, the brightness and sharpness of the through image are adjusted strictly. In a step S53, it is determined whether or not the shutter button 34sh is fully depressed, and in a step S55, it is determined whether or not the operation of the shutter button 34sh is cancelled.

When YES is determined in the step S55, the process directly returns to the step S45. Moreover, when YES is determined in the step S53, the recording process is executed in a step S57, and thereafter, the process returns to the step S45.

With reference to FIG. 11, in a step S61, the mapping state of the flash memory 38 is recognized with reference to the register RGST1 which is set as shown in FIG. 5(A). As a result, the flash memory 38 is recognized as having the mapping shown in FIG. 6(A).

In a step S63, the latest image file on the data area 1 is detected with reference to the description of the directory entry 1 so as to designate the detected image file as a reproduction file. In a step S65, the I/F 36 and the LCD driver 26 are commanded to execute the reproduction process in which the designated image file is noticed.

The I/F 36 reads out the image data accommodated in the designated image file from the data area 1 with reference to the FAT1, and writes the read-out image data into the SDRAM 24 through the memory control circuit 22. The LCD driver 26 reads out the image data accommodated in the SDRAM 24, through the memory control circuit 22, and drives the LCD monitor 28 based on the read-out image data. As a result, the reproduction image is displayed on the LCD monitor 28.

In a step S67, it is determined whether or not the image forward/backward button 34fr is operated. When the determined result is updated from NO to YES, the process advances to a step S69 so as to designate the succeeding image file or the preceding image file with reference to the directory entry 1. Upon completion of the designating process, the process returns to the step S65. As a result, another reproduction image is displayed on the LCD monitor 28.

With reference to FIG. 12, in a step S71, the mapping state of the flash memory 38 is recognized with reference to the register RGST1 which is set as shown in FIG. 5(B). As a result, the flash memory 38 is recognized as having the mapping shown in FIG. 6(B).

In a step S73, the font data accommodated in the flash memory 40 is applied to the character generator 30 in order to display the menu image. As a result, the menu image shown in FIG. 7(A) or FIG. 7(B) is displayed on the LCD monitor 28.

It is determined in a step S75 whether or not the item of [symbol] or “exposure setting” is selected, it is determined in a step S79 whether or not the item of [symbol] or “focus setting” is selected, and it is determined in a step S83 whether or not the item of [symbol] or “change font” is selected.

When YES is determined in the step S75, the exposure mode is changed in a step S77, and when YES is determined in the step S79, the focus mode is changed in a step S81. Upon completion of the process in the step S77 or S81, the process returns to the step S75.

When YES is determined in the step S83, the process advances to a step S85 so as to read out the alternate font data accommodated in the flash memory 38 through the I/F 36. In a step S87, the read-out alternate font data is overwritten to the font data accommodated in the flash memory 42. Upon completion of the process in the step S87, the process returns to the step S73.

With reference to FIG. 13, in a step S91, the mapping state of the flash memory 38 is recognized with reference to the register RGST1 which is set as shown in FIG. 5(C). As a result, the flash memory 38 is recognized as having the mapping shown in FIG. 6(C).

In a step S93, it is determined whether or not the USB cable CBL1 is connected to the USB device 42. When the determined result is NO, the predetermined notification is outputted in a step S95, and thereafter, the process returns to the step S93. When the determined result is YES, the menu data described with two items of “operation manual” and “image file” is transferred to the PC through the USB device 42.

In a step S99, it is determined whether or not the item selected by the PC is “operation manual”, and in a step S101, it is determined whether or not the item selected by the PC is “image file”. When YES is determined in a step S99, the process advances to a step S103, and when YES is determined in a step S101, the process advances to a step S107.

In the step S103, the operation manual data is read out from the flash memory 38 through the I/F 36, and in a step S105, the read-out operation manual data is transferred to the PC through the USB device 42. In the step S107, the image file is read out from the flash memory 38 through the I/F 36, and in a step S109, the read-out image file is transferred to the PC through the USB device 42. Upon completion of the process in the step S105 or S109, the process returns to the step S99.

As can be seen from the above-described explanation, in the flash memory 38, the plurality of slots 1 to 3 are formed. Moreover, in the MBR of the flash memory 38, the slot numbers SL1 to SL3 respectively identifying the slots 1 to 3 are described. The CPU 32 accesses the flash memory 38 under the imaging task, the reproducing task, the setting change task, or the USB communication task (S41, S57, S61, S65, S71, S85, S91, S103, S107). Herein, the imaging task is allocated to the camera mode, and the reproducing task is allocated to the reproducing task. Moreover, the setting change task is allocated to the setting change mode, and the USB communication task is allocated to the USB communication mode.

The CPU 32 accepts the selection operation which selects any one of these operation modes under the main task (S3, S7, S19, S27), and designates, based on the slot numbers described in the MBR, a part of slots corresponding to the operation mode selected by the selection operation out of the slots 1 to 3 (S13, S25, S33, S37). Moreover, the CPU 32 permits the task corresponding to the operation mode selected by the selection operation out of the imaging task, the reproducing task, the setting change task and the USB communication task to access the designated part of slots (S5, S9, S21, S29).

By preparing the slot numbers SL1 to SL3 which identify the slots 1 to 3 in the flash memory 38, it becomes possible to avoid the misrecognition of the slot attributed to the change of the program which controls to access the flash memory 38. Moreover, by permitting the task corresponding to the selected operation mode to access the designated slot, it becomes possible to creatively use the flash memory 38 depending on the operation mode. Thus, usability of the flash memory 38 having the slots 1 to 3 is improved.

Moreover, in this embodiment, the EBR1 which defines only the mapping state of the slot 1 is arranged in the slot 1 so as to be accessible by the external PC. Thus, by setting the slot number identifying the slot 1 to the register RGST1 corresponding to the USB communication mode, it becomes possible to make the PC misapprehend that the flash memory 38 has only the slot 1.

It is noted that the digital camera is assumed in this embodiment; however, the present invention is possible to be adapted to any electronic devices which have a plurality of operation modes and access the recording medium.

Moreover, in this embodiment, the program and the data are dispersively memorized in the NOR-type flash memory 40 and the NAND-type flash memory 38; however, the program and the data may be memorized together in the NAND-type flash memory 38.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An access control apparatus, comprising:
a plurality of accessors which are respectively allocated to a plurality of operation modes in order to access a recording medium having a plurality of partitions and identification information which identifies each of said plurality of partitions;
an acceptor which accepts a selection operation which selects any one of the plurality of operation modes;
a first designator which designates, based on the identification information provided in said recording medium, a part of partitions corresponding to the operation mode selected by the selection operation out of said plurality of partitions; and
a permitter which permits an accessor corresponding to the operation mode selected by the selection operation out of said plurality of accessors to access the partition designated by said first designator.

2. An access control apparatus according to claim 1, wherein said recording medium, holding the identification information, has a master boot record which defines a mapping of said plurality of partitions, and at least one of said plurality of partitions has an extended boot record which defines a mapping of its own partition.

3. An access control apparatus according to claim 2, further comprising a second designator which designates any one of said master boot record and said extended boot record in association with a designating process of said first designator, wherein the accessor permitted by said permitter recognizes a mapping state of said recording medium with reference to the boot record designated by said second designator.

4. An access control apparatus according to claim 1, wherein said plurality of partitions include a first partition which accommodates image data, the plurality of operation modes include an image recording/reproducing mode, and said plurality of accessors include a first accessor which accesses said first partition corresponding to the image recording/reproducing mode.

5. An access control apparatus according to claim 1, further comprising a reproducer which reproduces font data for display a guide, wherein said plurality of partitions include a second partition which accommodates alternate font data, the plurality of operation modes include a setting change mode, and said plurality of accessors include a second accessor which accesses said second partition corresponding to the setting change mode.

6. An access control apparatus according to claim 1, wherein said plurality of partitions include a third partition which accommodates operation manual data, the plurality of operation modes include an external transfer mode, and said plurality of accessors include a third accessor which accesses said third partition corresponding to the external transfer mode.

7. An access control program product executed by a processor of an access control apparatus, the access control program product comprising:
a plurality of accessing steps which are respectively allocated to a plurality of operation modes in order to access a recording medium having a plurality of partitions and identification information which identifies each of said plurality of partitions;
an accepting step which accepts a selection operation which selects any one of the plurality of operation modes;
a designating step which designates, based on the identification information provided in said recording medium, a part of partitions corresponding to the operation mode selected by the selection operation out of said plurality of partitions; and
a permitting step which permits an accessing step corresponding to the operation mode selected by the selection operation out of said plurality of accessing steps to access the partition designated by said designating step.

8. An access control method executed by an access control apparatus, the access control method comprising:
a plurality of accessing steps which are respectively allocated to a plurality of operation modes in order to access a recording medium having a plurality of partitions and identification information which identifies each of said plurality of partitions;
an accepting step which accepts a selection operation which selects any one of the plurality of operation modes;
a designating step which designates, based on the identification information provided in said recording medium, a part of partitions corresponding to the operation mode selected by the selection operation out of said plurality of partitions; and
a permitting step which permits an accessing step corresponding to the operation mode selected by the selection operation out of said plurality of accessing steps to access the partition designated by said designating step.
